(19) United States
(12) Patent Application Publication
(10) Pub. No.: US 2026/0322125 A1
(43) Pub. Date: Oct. 15, 2026

(54) INFORMATION PROCESSING DEVICE AND METHOD

(71) Applicant: TOYOTA JIDOSHA KABUSHIKI KAISHA, Toyota-shi (JP)

(72) Inventors: Tomoko MASUDA OKUZAWA, Tokyo (JP); Hiroshi ABE, Kasukabe-shi (JP); Kazuya OKADA, Tokyo (JP); Toru FURUSAWA, Yokohama-shi (JP)

(73) Assignee: TOYOTA JIDOSHA KABUSHIKI KAISHA, Toyota-shi (JP)

(21) Appl. No.: 19/535,309

(22) Filed: Feb. 10, 2026

(30) Foreign Application Priority Data
Apr. 10, 2025 (JP) 2025-065176

(51) Int. Cl. H02J 3/00; H02J 101/24

(52) U.S. Cl. CPC H02J 3/004; H02J 2101/24

(57) ABSTRACT

The information processing device determines, from the plurality of data centers, a first data center for processing communication from the first device based on the first information regarding the generated power for each of the plurality of data centers that use the generated power by the power generation facility as one of the power sources, the first data center for processing communication from the first device, generates route information regarding a route to the first data center for communication from the first device, and sets the route information to a first relay device for connecting a network to which the first device belongs.

### CROSS-REFERENCE TO RELATED APPLICATION

This application claims priority to Japanese Patent Application No. 2025-065176 filed on Apr. 10, 2025. The disclosure of the above-identified application, including the specification, drawings, and claims, is incorporated by reference herein in its entirety.

### BACKGROUND

### 1. Technical Field

The present disclosure relates to a data center that utilizes renewable energy.

### 2. Description of Related Art

An SR (Segment Routing) technique supports a source node in a forwarding path inserting segment information on the forwarding path into packets. It is indicated that in the SR (Segment Routing) technique, a network node calculates a forwarding path based on an SPF (Shortest Path Priority) algorithm (e.g., Japanese Patent No. 7527408).

### SUMMARY

In the conventional SR, path control is performed based on metrics such as the number of hops and delay, but the path control is not performed in consideration of the power at a destination data processing site.

The present disclosure has an object to provide an information processing device and a method capable of improving the utilization efficiency of generated power generated by a power generation facility that is one of power sources for each of a plurality of data centers.

An aspect of the present disclosure provides
an information processing device including a control unit that: determines a first data center that processes communication from a first device, from among a plurality of data centers, based on first information, the data centers using generated power generated by a power generation facility as one of power sources, and the first information being about the generated power for each of the data centers;
generates path information about a path to the first data center for the communication from the first device; and
sets the path information to a first relay device that connects a network to which the first device belongs.

Another aspect of the present disclosure provides a method executed by a computer, the method including:
determining a first data center that processes communication from a first device, from among a plurality of data centers, based on first information, the data centers using generated power generated by a power generation facility as one of power sources, and the first information being about the generated power for each of the data centers;
generating path information about a path to the first data center for the communication from the first device; and
setting the path information to a first relay device that connects a network to which the first device belongs.

According to the present disclosure, it is possible to improve the utilization efficiency of generated power generated by a power generation facility that is one of power sources for each of a plurality of data centers.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a configuration of a communication system;

FIG. 2 is a diagram illustrating an example of a hardware configuration of a control device;

FIG. 3 is a diagram illustrating an exemplary functional configuration of a control device; and

FIG. 4 is an example of a flowchart of processing place determination processing of the control device.

### DETAILED DESCRIPTION OF EMBODIMENTS

According to an aspect of the present disclosure, there is provided an information processing device including: a control unit configured to determine, from among a plurality of data centers, a first data center for processing communication from the first device based on first information regarding the generated power for each of a plurality of data centers that use the generated power by the power generation facility as one of the power sources; generate route information regarding a route to the first data center of the communication from the first device; and set the route information to a first relay device that connects a network to which the first device belongs.

The information processing device is, for example, a dedicated or general-purpose computer or a dedicated device. The control unit is, for example, a processor such as CPU (Central Processing Unit), GPU (Graphics Processing Unit), or DSP (Digital Signal Processor). Alternatively, the control unit is an electric circuit such as FPGA (Field-Programmable Gate Array) or ASIC (Application Specific Integrated Circuit).

A data center is a facility that includes, for example, at least one or more of a group of computers, servers, storage, and communication devices that perform predetermined processing. The power generation facility may be a power generation facility that utilizes renewable energy or a power generation facility that utilizes fossil fuel. The power generation facility using renewable energy is, for example, a power generation facility using solar light, hydroelectric power, wind power, or biomass fuel.

The first device is, for example, a terminal device or a relay device. The terminal device is, for example, a PC (Personal Computer), a smart phone, a tablet terminal, a wearable terminal, or the like. The route information regarding the route from the first device to the first data center of the communication may be route information regarding the first device or route information regarding each device belonging to the network to which the first device belongs. The network is a domain of layer 3 and is a range in which communication and routing are managed. Devices belonging to the same network use the same network address of IP address. The first relay device is, for example, a router or a gateway device.

According to one aspect of the present disclosure, a first data center to which communication is destined is determined based on first information regarding generated power for the data center. Therefore, it is possible to improve the utilization efficiency of the generated power by the power generation facility that is one of the power sources of each of the plurality of data centers.

In one aspect of the present disclosure, the power generation facility may generate electric power using renewable energy. In this case, the first information may include a prediction result regarding the suppliable power for the renewable power by the power generation facility that is the power source of the data center. The control unit may determine, as the first data center, a data center in which the surplus of the renewable power is predicted on the basis of a prediction result regarding the suppliable power for each of the plurality of data centers. The surplus of the renewable electric power means that the generated electric power or the generated amount of the renewable electric power exceeds the electric power demand of the data center in a predetermined period.

According to one aspect of the present disclosure, a first data center to which the communication is destined is determined, for example, to a data center in which the surplus of the renewable power is predicted based on a prediction result regarding the suppliable power in each data center. As a result, it is possible to reduce renewable power that is discarded without being consumed.

In one aspect of the present disclosure, the power generation facility may generate electric power using renewable energy. In this case, the first information may include a utilization rate or a utilization efficiency of the renewable power. The utilization rate of the renewable power is, for example, a ratio of the amount of power consumption derived from the renewable power to the total amount of power consumption in the data center. The utilization efficiency of the renewable power is, for example, a ratio of the amount of electric power actually used to the amount of renewable electric power generated by the power generation facility.

According to one aspect of the present disclosure, a first data center to which communication is destined is determined to be a data center where renewable power may have been discarded. Examples of data centers where renewable power may be discarded are data centers with lower utilization of renewable power or data centers with lower utilization efficiency of renewable power. As a result, it is possible to reduce renewable power that is discarded without being consumed.

In one aspect of the present disclosure, the control unit may determine the first data center based further on at least one of information about the first device or information about each of the plurality of data centers. The information about the first device may include, for example, one or more of a communication amount of the first device, location information of the first device, a distance from the data center, and the like. The information related to the data center may include, for example, information related to a computational resource, position information of the data center, and the like. According to one aspect of the present disclosure, the first data center to be the destination may be different for at least the first device.

As another aspect, the present disclosure can be specified as a method by which the information processing device executes the processing. As another aspect, the present disclosure can also be specified as a program for causing a computer to execute the above-described method and a non-transitory computer-readable recording medium on which the program is recorded.

Hereinafter, embodiments of the present disclosure will be described with reference to the drawings. The configurations of the following embodiments are illustrative, and the present disclosure is not limited to the configurations of the embodiments.

### First Embodiment

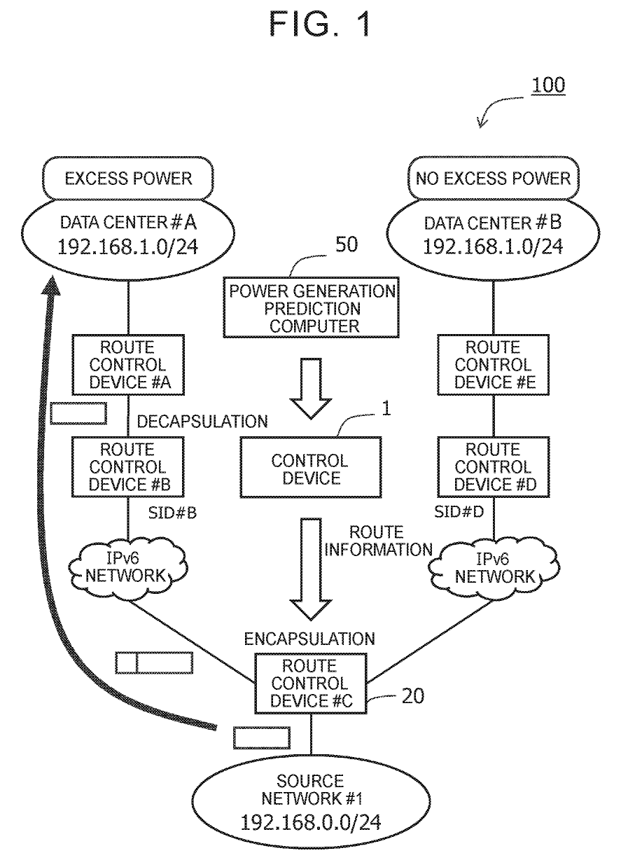

FIG. 1 is a diagram illustrating an example of a configuration of a communication system 100. The communication system 100 includes a plurality of data centers and a plurality of transmission source networks serving as transmission sources of requests to the data centers. Further, the communication system 100 includes a plurality of route control devices that connect a network to which each data center belongs and a network of each transmission source, and a control device 1. The plurality of data centers performs the same processing. FIG. 1 illustrates a data center #A and a data center #B representing a plurality of data centers. When the data center #A and the data center #B are not distinguished from each other, they are simply referred to as a data center. FIG. 1 shows a transmission source network #1 as a representative of a plurality of transmission source networks. FIG. 1 illustrates a route control device #A, #B, #C, #D, #E representing a plurality of route control devices. When the route control device is not distinguished, it is referred to as a route control device 20.

In the embodiment illustrated in FIG. 1, the network to which the data center #A belongs, the network to which the data center #B belongs, and the transmission source network #1 are each a local network. The network to which the data center #A belongs and the network to which the data center #B belongs are assigned the same IPv4 of network addresses (192.168.1.0/24). At IPv4 level, when viewed from the source network, the network to which the data center #A belongs and the network to which the data center #B belongs are visible to the same network.

In the embodiment shown in FIG. 1, between the path controller #B and the path controller #C, and between the path controller #C and the path controller #D, respectively, are connected via WAN (Wide Area Network) of IPv6. The path control device #B, the path control device #C, and the path control device #D execute the respective path control devices 20 SRv6 (Segment Routing over IPv6). In SRv6, SRv6 SID (Segment Identifier) and SRv6 Behavior are defined. SRv6 SID is the identification information of the respective segments. IPv6 addressing is used for SID. In the embodiment shown in FIG. 1, it is assumed that a SID #B is assigned to the path control device #B and a SID #D is assigned to the path control device #D. In the route control device #C, the route to the data center #A is connected by a segment of SID #B, and the route to the data center #B is connected by a segment of SID #D, so that the data center #A and #B can be distinguished by SRv6 SID.

SRv6 Behavior defines operations in the respective path control devices 20. SRv6 Behavior defines, for example, an operation of encapsulating a packet and an operation of decapsulating a packet and forwarding the packet to a particular interface. In addition, SRv6 Behavior defines an operation of decapsulating a packet and searching for a destination in a particular table. Encapsulation headers include SID of next-hops, source SID, and segment-list as destinations. The segment list includes segments that pass from the transmission source to the destination in order of passage. The destination search table is, for example, a FIB table. However, the table for the destination search is not limited thereto. The destination search table stores, for example, a destination network (IPv4 or IPv6 address, subnet), a next hop (next SRv6 node, interfaces used for forwarding), and an association of segment lists.

For example, in the path control device #C, a SRv6 Behavior is set in which IPv4 packets are encapsulated by SRv6 SID. For example, in the route control device #B, a SRv6 Behavior is set in which the encapsulation of the packets is cancelled and the packets are transferred to the interfaces to which the data center #A is connected. For example, in the route control device #D, a SRv6 Behavior is set in which the encapsulation of the packets is cancelled and the packets are transferred to the interfaces to which the data center #B is connected.

Accordingly, the path control device #B, the path control device #C, and the path control device #D of the embodiment shown in FIG. 1 operate as follows. When the route control device #B receives a packet addressed to the data center from the device in the source network #1, it searches for a destination search table. The path controller #B forwards the packet to the path controller #B or the path controller #D by encapsulating it with headers containing segment SID #B connected to the path controller #B or segment SID #D connected to the path controller #D as destinations. Upon receiving an encapsulated packet including its SID as a destination, the routing device #B or the routing device #D decapsulates (unencapsulates) the packet and forwards the packet from the interface to which the destination data center is connected.

In the first embodiment, the data center #A and the data center #B include a power generation facility that utilizes renewable energy, and the power generated by the power generation facility is one of power sources. The data center includes one or more of the computer group, server group, storage group, and communication device group. The renewable energy is, for example, solar, wind, or hydro. Electric power generated or supplied by a power generation facility using renewable energy is also referred to as renewable electric power.

In a power generation system using renewable energy, although the power generation amount fluctuates depending on weather conditions, it is difficult to adjust the power generation amount. Therefore, depending on weather conditions and time periods, there arises a phenomenon in which the power that can be supplied to the renewable power exceeds the power demand of the data center and the generated power is left over. The renewable power exceeding the power demand of the data center is referred to as surplus power.

In the first embodiment, the control device 1 sets the path control device #C to transmit the packet to the area where the surplus of the renewable power is expected based on the prediction regarding the suppliable power by renewable energy. The route information set in the route control device #C is, for example, an entry of a table for destination search.

The prediction result regarding the suppliable power by the renewable energy is obtained from, for example, the power generation prediction calculator 50. For example, in the case of the prediction of the photovoltaic power generation, the power generation prediction calculator 50 refers to the latest weather forecast (predicted value of the solar radiation amount for each time) of the position of each data center and the past weather information (history of the solar radiation amount). Then, the power generation prediction calculator 50 calculates photovoltaic power generation data obtained by the photovoltaic power generation facility of each data center. The weather forecast and the past weather information are obtained, for example, with reference to a weather database published by the Meteorological Agency. The power generation prediction calculator 50 calculates prediction data of the power that can be supplied in units of several days from the latest unit of several hours, and holds the prediction data in a database. Note that the present disclosure is not limited to this, and the control device 1 may acquire the prediction result regarding the suppliable power by the renewable energy in the same manner as the power generation prediction calculator 50.

According to the first embodiment, the path information is set in the path control device that connects the source network so as to transfer the packet to the data center in which the surplus of the renewable power is expected. As a result, more packets are transferred to the data center where the surplus of the renewable power is expected, and the surplus of the renewable power is consumed in the processing of the packet, so that the waste of the renewable power can be reduced.

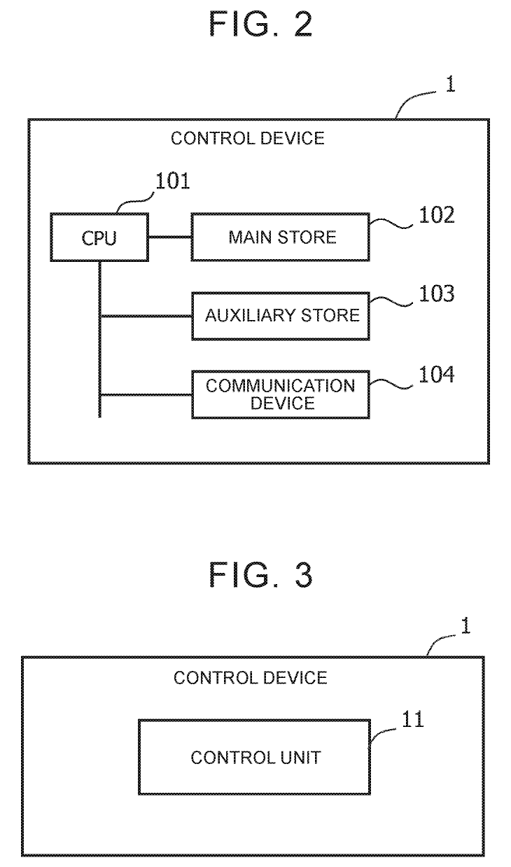

FIG. 2 is a diagram illustrating an example of a hardware configuration of the control device 1. The control device 1 includes a CPU 101, a main storage device 102, an auxiliary storage device 103, and a communication device 104 as hardware configurations. The main storage device 102 and the auxiliary storage device 103 are computer-readable recording media.

The auxiliary storage device 103 stores various programs and data used by the processor 101 when executing the programs. The auxiliary storage device 103 is, for example, an EPROM (Erasable Programmable Read-Only Memory, a hard disk drive, or an SSD (Solid State Drive). Examples of the program stored in the auxiliary storage device 103 include an operating system (OS), an application program, and a process location determination program.

The main storage device 102 is a storage device that provides a storage area and a work area for loading programs stored in the auxiliary storage device 103 to the processor 101, and is used as a buffer. The main storage device 102 includes, for example, ROM (Read Only Memory) and RAM (Random Access Memory).

The processor 101 loads a program stored in the auxiliary storage device 103 into the main storage device 102 and executes the program, thereby executing various processes. The processor 101 is, for example, a CPU, GPU or a DSP. The number of processors 101 is not limited to one, and a plurality of processors may be provided.

The communication device 104 is connected to a wired network and a wireless network, and communicates with other devices. The communication device 104 is, for example, an NIC (Network Interface Card), an optical signal transmitting device and a receiving device for optical communication, and a radio LAN (Local Area Network). Alternatively, the communication device 104 is a wireless circuit or the like for connecting to a mobile phone network. Note that the hardware configuration of the control device 1 illustrated in FIG. 2 is an example, and is not limited to the configuration illustrated in FIG. 2. The control device 1 may be a device including electric circuitry such as a dedicated FPGA or ASIC for executing a corresponding process.

FIG. 3 is a diagram illustrating an example of a functional configuration of the control device 1. The control device 1 includes a control unit 11 as a functional configuration. These functional components are, for example, functions achieved by CPU 101 of the control device 1 executing the process location determination control program. The processing location is a location of the data center, and is a location where a packet transmitted from a device belonging to the transmission source network in the communication system 100 is processed.

The control unit 11 performs processing location determination processing for determining a data center for processing a packet at a predetermined cycle or in response to an execution instruction from the communication system 100. The execution cycle of the processing place determination process is, for example, 10 minutes, 15 minutes, 30 minutes, 1 hour, several hours, or one day, and can be arbitrarily set according to the type of renewable energy used by the power generation facility by the administrator of the communication system 100.

The control unit 11 acquires, from the power generation prediction calculator 50, power generation prediction information of each data center in a predetermined period from the current time. For example, the control unit 11 transmits, to the power generation prediction calculator 50, information related to the power generation facility using the renewable power of each data center together with the request, and acquires the power generation prediction information of each data center. The predicted power generation data may be, for example, a transition of the suppliable power (W) of each data center at each time of the predetermined time period, or may be a suppliable power quantity (Wh) of each data center in each time period. In some cases, the control unit 11 itself predicts the suppliable power of each data center. In this case, for example, the control unit 11 may acquire the weather forecast information from a predetermined server, and perform prediction using a predetermined method, a machine learning model, or the like, based on the weather forecast information, information on the power generation capability of the power generation facility of each data center, and the like. The power generation prediction information is an example of "a prediction result regarding suppliable power for renewable power by a power generation facility".

The control unit 11 determines a data center for processing a packet based on power generation prediction information of each data center in a predetermined period in the future. In the first embodiment, the control unit 11 predicts the surplus electric power (W) or the surplus electric power (Wh) of the renewable electric power for the respective data centers based on the power generation prediction information. Then, the control unit 11 determines the data center having the largest surplus power or surplus amount as the data center that processes the packet. The predicted value of the surplus power or the surplus amount may be determined, for example, as the power or the amount of power that exceeds a threshold value for the predicted value of the suppliable power or the predicted value of the suppliable power amount. The threshold value for the predicted value of the suppliable power or the predicted value of the suppliable power amount may be a uniform value for each data center or may be different for each data center. In the case of being different for each data center, for example, the threshold value for the predicted value of the suppliable power or the predicted value of the suppliable power amount may be a value obtained by multiplying the maximum power consumption or the maximum power consumption amount of the data center by a predetermined coefficient. Without being limited thereto, the predicted value of the surplus power or the surplus amount may be obtained by subtracting the demand power or the demand power amount of each data center from the predicted value of the suppliable power or the predicted value of the suppliable power amount.

Note that the criterion of the data center that processes the packet is not limited to the predicted value of the surplus power or the surplus amount. For example, the criterion of the data center that processes the packets may be the suppliable power (W) or the suppliable power (Wh) over a predetermined time interval. In addition, as a selection condition of the data center for processing the packet, a data center having a larger amount of power that can be supplied or a larger amount of power that can be supplied in a predetermined period may be determined as the data center for processing the packet. The criterion of the data center that processes the packet is not limited to the criterion based on the power generation prediction information of each data center, and may be, for example, the utilization rate or the utilization efficiency of the renewable power of each data center. The utilization rate or the utilization efficiency of the renewable power of each data center may be obtained from, for example, a server that centrally manages each data center, a server disposed in each data center, or the like. Alternatively, the control unit 11 may monitor the power generation amount, the power consumption, and the like of the renewable power in each data center to obtain the utilization rate or the utilization efficiency of the renewable power.

The utilization rate of the renewable power of the data center is, for example, a ratio of the amount of electric power consumed from the renewable power to the total amount of electric power consumed in the data center. For example, the control unit 11 may determine the data center having the lowest utilization rate of the renewable power as the data center that processes the packet. The low utilization rate of the renewable power is because it is indicated that the amount of power consumed due to the renewable power is small, that is, the amount of renewable power discarded may be large.

The utilization efficiency of the renewable power of the data center is, for example, a ratio of the amount of electric power actually used to the amount of renewable electric power generated by the power generation facility. For example, the control unit 11 may determine the data center having the lowest utilization efficiency of the renewable power as the data center that processes the packet. The low utilization efficiency of the renewable power is because it is indicated that the amount of electric power actually used among the renewable electric power generated by the power generation facility is small, that is, there is a possibility that the amount of renewable electric power discarded is large. Note that the criterion and the selection condition of the data center that processes the packet are not limited to the above.

In addition, the control unit 11 may determine a data center that processes packets in units of a network, a subnet, or a device of a transmission source so that packets do not concentrate too much in one data center. In this case, the control unit 11 may determine the data center to process the packet based on at least one of the following information in addition to the predicted value of the surplus power or the surplus amount of the renewable power of each data center. The information that may be added to the predicted value of the surplus power or the surplus amount of the renewable power of each data center is information about the network or information about the device, or information about the data center. The information about the network or device may include, for example, the amount of communication of the network or device and/or the location of the network or device. The information about the data center may include, for example, information about computational resources provided in the data center, and/or a location of the data center.

For example, the control unit 11 may determine, as the data center that processes the packet, a data center in which the predicted value of the surplus power or the surplus amount of the renewable power is larger as the communication amount is larger or the network is larger. The control unit 11 may determine, for example, a data center that processes a data center packet including a larger number of computational resources among data centers in which the surplus of renewable power is predicted as the communication amount is larger or the network. For example, the control unit 11 may determine, as the data center that processes the packet, a data center having a lower utilization rate of computational resources among the data centers in which the surplus of the renewable power is predicted as the communication amount is larger or the network. For example, the control unit 11 may determine, as the data center that processes the packet, the data center having the closest distance to the transmission source device or the network among the data centers in which the surplus of the renewable power is predicted.

In the case of determining a data center for processing packets in units of a network, a subnet, or a device as a transmission source, the control unit 11 may use a machine learning model. For example, the machine learning model has already learned a relationship between power generation prediction information of each data center, information about each data center, information about a network or information about a device, and a data center that processes a packet of the network or the device. The machine learning model outputs a data center that processes a packet of the network or the device when the power generation prediction information of each data center, the information about each data center, and the information about the network or the information about the device are input.

When determining a data center for processing packets, the control unit 11 generates route information and notifies the route control device 20 to which the transmission source network or the transmission source device is connected of the route information to set the route information. The control unit 11 holds information related to all the path control devices 20 in the communication system 100. For example, IPv4 addresses and IPv6 addresses (SID) of the route control devices 20 and the connectivity between the route control devices 20 are included in the information about all the route control devices 20 in the communication system 100.

When the communication system 100 illustrated in FIG. 1 is used as an example, the control unit 11 converts, for example, the destination IPv4 address 192.168.1.0 into a destination IPv6 address that connects to the data center #A: SID #B, and generates route information in which SRv6 node of SID #B is set as the next hop. Alternatively, the control unit 11 generates route data indicating that an interface connected to SID #B is used as a forwarding interface. When the route information is notified to the route control device 20, the route information is added by the route control device 20, for example, as an entry of a table for destination search.

Note that the control unit 11 may generate a route order of SRv6 segment to the data center where the packet is processed, include the route order in the route information, and notify the route control device 20 of the route order. The route order of SRv6 segment to the data center in which the packets are processed is added to the destination search table of the route control device 20 as a segment list. When there is a plurality of routes from the source network to the data center that performs packet processing, the control unit 11 may select, for example, a route having the lowest utilization rate of the renewable power. The utilization rate of the renewable power of the path may be, for example, a sum of the utilization rates of the renewable power of each path control device 20 on the path, an average value, a median value, a minimum value, or a maximum value. Alternatively, the utilization rate of the renewable power of the path may be randomly selected among the path control devices 20 on the path, and any of the utilization rates of the renewable power of the path control device 20 may be used. Note that the functional configuration of the control device 1 is not limited to the example illustrated in FIG. 3.

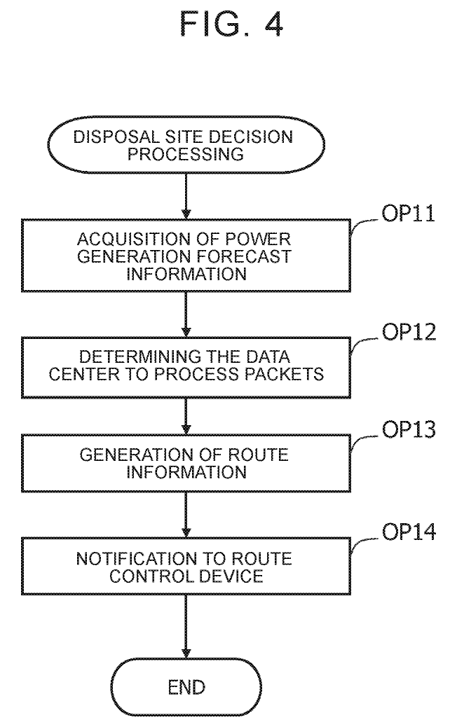

FIG. 4 is an example of a flowchart of processing place determination processing of the control device 1. The processing illustrated in FIG. 4 is executed at a predetermined cycle, for example. Although the process illustrated in FIG. 4 is mainly executed by CPU 101, for convenience, functional components will be mainly described.

In OP11, the control unit 11 acquires the power generation prediction data of the respective data centers from the power generation prediction calculator 50. In OP12, the control unit 11 acquires a predicted value of the surplus power or the surplus amount of the renewable power of each data center based on the power generation prediction information of each data center. In OP12, the control unit 11 determines the data center having the largest predicted value of the surplus power or the surplus amount of the renewable power as the data center that processes the packets. In OP13, the control unit 11 generates, in the path control device 20 to which the source network or the device is connected, path information in which the packet is transferred to the data center that processes the packet determined by OP12. In OP14, the control unit 11 notifies the route control device 20 to which the source network or the device is connected of the route information generated by OP13. After that, the process shown in FIG. 4 ends.

Note that the processing place determination processing of the control device 1 is not limited to the processing illustrated in FIG. 4. When the data center that processes the packet is determined for each of the transmission source, the network, and the sub-network, the processing illustrated in FIG. 4 may be executed for each unit of the data center that processes the packet, or may be executed simultaneously for all transmission sources. Alternatively, in a case where the data center for processing packets is determined for each device, the processing illustrated in FIG. 4 may be executed for each unit of the data center for processing packets, or may be executed simultaneously for all transmission sources.

### Action Effect of First Embodiment

In the first embodiment, based on the power generation prediction information of the renewable energy of each data center, the data center in which the surplus of the renewable power is expected is determined as the data center that processes the packet. Accordingly, even when an excess of renewable power is generated, it is highly likely that the excess power is consumed by the processing of the packet, and thus the generated renewable power can be used without waste.

### Other Embodiments

The above-described embodiment is merely an example, and the present disclosure may be appropriately modified and implemented without departing from the scope thereof.

In the first embodiment, the path control device 20 executes SRv6, but is not limited thereto. For example, even when the route control device 20 performs source routing, the processing place determination processing described in the first embodiment can be applied. Source routing includes L3DSR (Layer 3 Direct Server Return), MPLS (Multiprotocol Label Switching), Policy-Based Routing (PBR), etc.

The processes and means described in the present disclosure can be freely combined and implemented as long as no technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium includes any type of disk such as a magnetic disk (floppy (registered trademark) disk, hard disk drive (HDD), etc.) and an optical disc (CD-ROM, DVD disc, Blu-ray disc, etc.). Non-transitory computer-readable storage media include, for example, read only memory (ROM), random access memory (RAM), EPROM, EEPROM, magnetic cards, flash memory, optical cards, any type of media suitable for storing electronic instructions.

What is claimed is:

1. An information processing device comprising a control unit that:
determines a first data center that processes communication from a first device, from among a plurality of data centers, based on first information, the data centers using generated power generated by a power generation facility as one of power sources, and the first information being about the generated power for each of the data centers;
generates path information about a path to the first data center for the communication from the first device; and
sets the path information to a first relay device that connects a network to which the first device belongs.

2. The information processing device according to claim 1, wherein:
the power generation facility generates power utilizing renewable energy;
the first information includes a prediction result regarding suppliable power for renewable power from the power generation facility as a power source for the data centers; and
the control unit determines, as the first data center, a data center predicted to have extra renewable power based on the prediction result regarding the suppliable power for each of the data centers.

3. The information processing device according to claim 1, wherein:
the power generation facility generates power using renewable energy; and
the first information includes a utilization rate or a utilization efficiency of renewable power.

4. The information processing device according to claim 1, wherein the control unit determines the first data center further based on at least one of information about the first device or information about each of the data centers.

5. A method executed by a computer, the method comprising:
determining a first data center that processes communication from a first device, from among a plurality of data centers, based on first information, the data centers using generated power generated by a power generation facility as one of power sources, and the first information being about the generated power for each of the data centers;
generating path information about a path to the first data center for the communication from the first device; and
setting the path information to a first relay device that connects a network to which the first device belongs.
